(19) United States
(12) Patent Application Publication
(10) Pub. No.: US 2022/0326425 A1
(43) Pub. Date: Oct. 13, 2022

(54) Optical Display Device

(71) Applicant: InnerScene Limited, Gloucester (GB)

(72) Inventor: Sean Flynn, Gloucester (GB)

(73) Assignee: InnerScene Limited, Gloucester (GB)

(21) Appl. No.: 17/718,092

(22) Filed: Apr. 11, 2022

(30) Foreign Application Priority Data
Apr. 13, 2021 (GB) 2105261.8

(51) Int. Cl. F21V 8/00

(52) U.S. Cl. CPC G02B 6/006; G02B 6/0055; G02B 6/004

(57) ABSTRACT

An optical display device that creates a perception of a sky scene in output light, the device comprising: a light source; a reflector block having a reflective member and a reflective and partially transmissive member; a diffuse light generator; a visual cue creating system associated with the reflector block, and an aperture for the output light, the light source arranged to transmit light to the reflector block for reflection between the reflective member and reflective and partially transmissive member, with light transmitted through the reflective and partially transmissive member to the aperture, the diffuse light generator arranged to generate in the output light a diffuse light component to replicate a skylight from the light transmitted from the light source, the visual cue creating system causes light in the reflector to block a visual cue arranged to provide in the output light a visual cue component that observers associate with depth.

### TECHNICAL FIELD

The present disclosure relates generally to electrically operated optical display devices for creating an artificial skylight, wherein an observer experiences a perception of a sky scene when gazing into an output aperture of said device.

### BACKGROUND

A device that creates a perception of a skylight is provided in EP3181999. Said device generates a collimated beam of light, which is transmitted through a partially transparent diffuse light generator. A portion of the collimated beam is scattered by the diffuse light generator as blue diffuse light to provide an artificial sky and a portion of the collimated beam passes through the diffuse light generator to provide an artificial sun. Such devices are expensive and complex to construct since they require precise alignment of optics and a collimating lens system. They also lack another visual cues to enhance the simulation of the skylight.

Therefore, in spite of the effort already invested in the development of said devices further improvements are desirable.

### SUMMARY

The present disclosure provides an optical display device arranged to create a perception of sky scene in output light, the device comprising: a light source; a reflector block having a reflective member and a reflective and partially transmissive member, and; an output aperture for the output light. The light source is arranged to transmit light to the reflector block for reflection between the reflective member and the reflective and partially transmissive member, with said light being transmitted through the reflective and partially transmissive member (e.g. a portion of the light incident on said member is reflected and a portion of the light is transmitted through said member) to the output aperture.

As used herein the term “between” in respect of said reflective members may refer to transmitting the light into a cavity between the members so that the light can reflect back and forth from the members within said cavity.

In embodiments, the optical display device includes a diffuse light generator, wherein the diffuse light generator is arranged to generate in the output light a diffuse light component which may replicate a skylight or other scene. The diffuse light component may alternatively be referred to as a skylight component. The diffuse light generator may generate the diffuse light component from the light from the light source that transmits to the reflector block, or via a dedicated light source (e.g. a dedicated edge lit light source).

With a diffuse light generator implemented, the light from the light source is therefore 1) processed to diffuse light, and 2) reflected between the reflective member and the reflective and partially transmissive member (1 and 2 can be implemented in either order), before being output as the output light. The output light may replicate skylight, which is both diffuse and has the perception of being at infinity. Moreover, compared to the cited prior art arrangement, the device provides a skylight but without the additional high cost of a collimator.

In embodiments, the optical display device includes a visual cue creating system, which is associated with the reflector block. The visual cue creating system implements in the light in the reflector block a visual cue, which is arranged to provide in the output light a visual cue component that an observer associates with depth. As used herein the term “observer associates with depth” in respect of the visual cue may refer to a geometric arrangement of said cue, e.g. a wall or a light spot, which extends to give a perception of a three dimensional structure.

By implementing the visual cue creating system, the sky scene may include a structural component (e.g. a wall or light source) that blends into the skylight or other scene to give an appearance of depth in the sky scene, and which may obviated the need for a physical structural component to create said depth, such as a frame.

In embodiments, the diffuse light generator is arranged between the reflective member and the reflective and partially transmissive member of the reflector block. By arranging the diffuse light generator between said members, the diffuse light generator may receive the light directly from the light source, e.g. before being reflected from one of said members. Moreover, the device may be more compact since the diffuse light generator is arranged in the space between said members, as opposed to on an exterior. Arranging the diffuse light generator between said members may encourage reflection between the members by scattering the light between the members. Arranging the diffuse light generator between said members may encourage light to exit from between said members by increasing an incidence angle of the light on the reflective and transmissive member.

In embodiments, the diffuse light generator is arranged to receive light after it has been transmitted through the reflector block (e.g. after it has been transmitted through the reflective and partially transmissive member). By arranging the diffuse light generator on or after an exterior emitting face of the reflective and partially transmissive member, the diffuse light generator may be more accessible, e.g. for servicing/assembly. The diffuse light component may also have a more infinite depth characteristic after being reflected between said members more than if the diffuse generator were arranged between said members.

In embodiments, the diffuse light generator is arranged upstream of the reflector block (e.g. so that it receives light prior to entry into the reflector block). By implementing such an arrangement, the diffuse light generator may be more accessible, e.g. for servicing/assembly.

In embodiments, the diffuse light generator is arranged as a light guide panel. By implementing the diffuse light generator as a light guide panel, it may be ensured that only diffuse light is transmitted there through due to non-diffuse light being retained in the light guide panel via total internal reflection.

In embodiments, the light source couples to an edge of the light guide panel, such that the light guide panel is edge lit by light from the light source. By implementing the diffuse light generator as edge lit by the light source, an additional light source for the diffuse light generator may be obviated.

In embodiments, the light guide panel is optically decoupled from the reflective member and/or the reflective and partially transmissive member. Such an arrangement may provide light at the output aperture with reduced interference, e.g. via reduction of interference including Newton rings.

In embodiments, the diffuse light generator generates the diffuse light component by scattering light which it receives, e.g. the light from the light source. In embodiments, the diffuse light generator includes particles to scatter said light. The particles may be micro particles or nano particles. The particles may be arranged in a particle carrying medium.

In embodiments, a degree of diffusivity in the diffuse light component corresponds (e.g. in terms of observer perception) to that present in skylight. By implying the diffuse light component to have the same degree of diffusivity as skylight, a realism of the sky scene may be increased.

In embodiments, the diffuse light component is emitted over a central portion of the output aperture and the visual cue component is emitted at a peripheral portion of the output aperture. In embodiment, the diffuse light component is uniform over the central region, e.g. with on other components present, including the visual cue component. The visual cue component may fade into the diffuse light component.

In embodiments, the diffuse light component comprises a skylight, that includes one or more of: daylight; sunset, and; sunrise. In embodiments, the diffuse light component is daylight and has a CCT of greater than 5000 k. With said CCT range the chromatic distribution of daylight may be suitably recreated.

In embodiments, a chromatic system imparts a skylight colour in the diffuse light component. The chromatic system may be implemented as one or more of: the light source arranged to emit a particular wavelength of light (e.g. by a coloured LED or other suitable source); the diffuse light generator (e.g. by Rayleigh scattering or an integrated filter), and; a filter (e.g. by a dichroic filter). By implementing a dedicated filter to colour the light from the light source, the filter may be replaced without replacing other components, e.g. for servicing to tune the particular colour. With the other examples a dedicated filter may be obviated.

In embodiments, the visual cue creating system is implemented as a wall creating portion, which is arranged to give in the visual cue component a perception of a virtual wall with depth extending into the output aperture. By implementing a wall creating portion, the device may have the appearance of a deep walled structure around a skylight (e.g. a well).

In embodiments, the virtual wall extends around an entire periphery of the output aperture. As used herein the term “entire periphery” may refer to the whole periphery continuously without a gap. The virtual wall may also extend continuously (e.g. without a gap) in the depth direction. In embodiments, the virtual wall may be configured to extend continuously along at least one edge of the output aperture.

In embodiments, the virtual wall has a CCT of 4500K to 6500K, e.g. the virtual wall appears as a white walled structure, which may blend into the blue daylight of the skylight.

In embodiments, the visual cue creating system (e.g. the wall creating portion) includes a luminescent based material, which may be continuous or as discrete portions. By implementing a luminescent based material to form the wall creating portion a vivid and relatively light colour may be imparted to the virtual wall. In embodiments, the luminescent material is 1 nm to 0.5 mm thick. In embodiments, luminescent based material is a fluorescent based material, which may be phosphorus based. By implementing a phosphorus based material the wall creating portion may create a white wall effect.

In embodiments, a reflective member is arranged adjoining, e.g. as a backing for, the luminescent based material. By implementing a reflective member as a substrate, e.g. to carry the luminescent based material, the light from the light source can be transmitted to the reflective member through the luminescent based material and reflected back through the luminescent material in this way light may be retained in the device.

In embodiments, the light source and visual cue creating system are arranged with the visual cue creating system to receive light from the light source that has been transmitted between the reflective member and the reflective and partially transmissive member (e.g. through the reflector block). By arranging the visual cue creating system so that it receives the transmitted light after it has been reflected between the reflective member and the reflective and partially transmissive member, the device may be conveniently arranged with the visual cue creating system and light source on opposed sides of the device to each other, which for example may facilitate convenient assembly or servicing of the device.

In embodiments, the visual cue creating system is arranged within the reflector block, e.g. between the reflective member and the reflective and partially transmissive member. By arranging the wall creating portion between the reflective member and the reflective and partially transmissive member, the device may be more convenient to manufacture.

In embodiments, the visual cue creating system is arranged on or is coupled to (e.g. including as via in intermediate member such as a filter or dedicated carrier) a side surface of the diffuse generator, the diffuse light generator may be at least partially arranged in the reflector block. In such an embodiment the light from the light source can project directly through (e.g. without an intermedial reflection) the visual cue creating system. By optically coupling the visual cue creating system to the side of the light guide panel of the diffuse light generator the device may be more convenient to manufacture.

In embodiments, the light from the light source projects though the visual cue creating system, e.g. it is arranged on a transparent member or printed on a component of the device. The visual cue creating system may be arranged as discrete units with gaps therebetween.

In embodiments, the wall creating portion is arranged a periphery (including proximal or at said periphery) of the reflector block, e.g. in proximity to the edges of the members so that the edges rather than a central portion are overlapped. By arranging the wall creating portion around the edges of the reflector block, the visual cue component may be arranged around the edges of the output aperture.

In embodiments the visual cue creating system is arranged on an exterior surface of the diffuse light generator, e.g. when arranged as a light guide panel, between the reflective member and the reflective and partially transmissive member. In embodiments, the visual cue creating system is arranged on an at least partially transparent carrier member, arranged between the reflective member and the reflective and partially transmissive member. The carrier member may be adjoining or adjacent the light guide panel. By arranging the wall creating portion by arranging the visual cue creating system on the light guide panel or a carrier, the device may be more convenient to manufacture. In both examples, the visual cue creating system can be on one or both of the major surface of the diffuse light generator, rather than a side surface).

In embodiments, the reflector block and visual cue creating system are arranged with light from the light source transmitted to the visual cue creating system upstream of the reflector block, e.g. before the light is reflected between the members. Such an arrangement may be convenient to manufacture.

In embodiments, an edge of the reflector block includes: an inlet portion to receive light from the light source, and/or; the visual cue creating system. Such an arrangement may be convenient to manufacture.

In embodiments, the light source includes a light emitting portion and a light guide to collect the light from the light emitting portion. In embodiments, the light guide couples the collected light to transmit said light between the reflective member and the reflective and partially transmissive member. By implementing a light guide to couple the light from the light emitting portion to the reflector block, the light may be efficiently directed between said members of the reflector block.

The present disclosure provides a kit of parts for assembly to the optical display device of any preceding embodiment or another embodiment disclosed herein.

The present disclosure provides, a method of creating a perception of a sky scene comprising (in any order): transmitting light comprising a visual cue between a reflective member and a reflective and partially transmissive member to generate a visual cue component; transmitting light to a diffuse light generator to generate a diffuse light component. The method may comprise combining in output light at the output aperture the diffuse light component and visual cue component. The method may implement the features of any preceding embodiment, or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Figures, and Claims.

### BRIEF DESCRIPTION OF FIGURES

Aspects, features and advantages of embodiments of the present disclosure will become apparent from the following description of embodiments in reference to the appended drawings in which like numerals denote like elements.

FIG. 1 is a block system diagram showing an embodiment optical display device.

FIG. 2 is a side cross-sectional view showing an embodiment of the optical display device of FIG. 1.

FIG. 3 is a side cross-sectional view showing an end portion of an embodiment of the optical display device of FIG. 1.

FIG. 4 is a side cross-sectional view showing an end portion of an embodiment of the optical display device of FIG. 1.

FIG. 5 is a side cross-sectional view showing an end portion of an embodiment of the optical display device of FIG. 1.

FIG. 6 is a perspective view showing graphical illustration of an output aperture of the optical display device of FIG. 1 when installed in a ceiling of a room.

### DETAILED DESCRIPTION OF EMBODIMENTS

Before describing several embodiments of the device, it is to be understood that the device is not limited to the details of construction or process steps set forth in the following description. It will be apparent to those skilled in the art having the benefit of the present disclosure that the device is capable of other embodiments and of being practiced or being carried out in various ways.

The present disclosure may be better understood in view of the following explanations:

As used herein the term “optical display device” or “device” may refer to electrically operated optical apparatus that is capable of providing an observer that perception of a sky scene when gazing into an output aperture of the device. The device may be dimensioned such that it is suitable for attachment to a ceiling or wall of an interior or a building.

As used herein the term “perception of infinite depth” may refer to a depth of an object (e.g. the sky and/or sun) in three dimensions being perceived as infinitely far away from an observer with stereopsis (i.e. binocular vision). A perception of infinite depth may be provided by one or more of the following monocular or binocular visual cues presented to an observer when looking into an output aperture of the device: motion parallax; interposition: aerial perspective; accommodation; stereopsis; convergence, and; other related cues.

As used herein the term “perception of a sky scene” may refer an observer perceiving a sky scene as being present in the real world, based on the construction by the device of a virtual sky scene that is sufficiently representative, e.g. in terms of chromatic and spatial distribution of light, to present as the real world.

As used herein the term “sky scene” may refer to a scene comprising a sky that an observer observes when gazing through a window (e.g. in a side wall or ceiling) of a structure. A sky scene may include a skylight component and a visual cue component as defined herein.

As used herein the term “skylight” or “skylight component” or “diffuse light component” may refer to artificial light that is representative of skylight, which can include daylight, sunset or sunrise. It may be representative of skylight in respect of one or more of: colour, e.g. as defined by a CCT; diffusivity (e.g. an angle of divergence of the light rays may be greater than 30, 50 or 70 degrees); luminance profile or intensity; other suitable parameter, and; a variance of any of the aforesaid over an output aperture of the device. The diffuse light component may be uniform such that is does not vary by more than 10% or 20% or 30% or 40% over the entire output aperture, e.g. in terms of one or more of: colour diffusivity; luminance profile; intensity, and other suitable parameter. More particularly, said one or more parameters may be uniform to the extent where they do not vary by more than 10% or 20% or 30% or 40% for any given circular area on the output aperture of 10 mm diameter over at least 90%. of the output aperture.

As used herein the term “output aperture” may refer to a viewing window of the device into which an observer can gaze. The output aperture may be 0.5-2 m×0.5-2 m.

As used herein the term “reflective member” may refer to an object that is capable of reflecting an image by specular reflection. It can include a member with any surface in which the texture or roughness of the surface is smaller (smoother) than the wavelength of the incident light. It may include surfaces formed of one or more of the following reflective materials: metals; metal oxides, and; dielectric materials. Examples of which include silver, aluminium, a titanium oxide based material including titanium dioxide or titanium trioxide. Any of the aforementioned may be applied as a thin coating on a glass carrier.

As used herein the term “a reflective and partially transmissive member” may refer to a reflective member as defined above, which is additionally configured to transmit therethrough a portion of light which is not reflected. An example of which is a member formed with a lesser thickness than for the aforedescribed reflective material. The transmissivity maybe less than 50% or 30% for incident electromagnetic radiation. The thickness of the reflective material may be any one or the following: less than 700 nm; less than 100 nm; less than 50 nm, and; less than 5 nm, with any of the aforementioned maximum thickness ranges implemented with a minimum thickness of 1 nm.

As used herein the term “diffuse light generator” may refer to a device capable of generating a diffuse light component, e.g. light which is scattered in many angles as opposed to one angle as with specular reflection. The diffuse light generator may generate the diffuse light by reflecting incident light as diffuse light or may be at least partially transparent and generate diffuse light in the light transmitted therethrough. The diffuse light generator may be implemented as one or more of the following: particles to scatter light; conical micro cones; micro lenses; quantum dots; surface features, including surface etching, and; other suitable implementation.

As used herein the term “scattering light” may refer to a process performed on incident light by the diffuse light generator to generate diffuse light.

As used herein the term “particles to scatter said light” may refer to particles with a diameter selected to scatter some or all wavelengths of visible light. The diameter of the particles may be micro or nano (e.g. to operate in the Rayleigh regime). The diffuse light generator can include said particles arranged in a medium. Examples include titanium dioxide suspended in PMMA.

As used herein the term “light guide panel” may refer to a generally planar member, which is arranged to convey light in the in plane direction, e.g. by total internal reflection. The light guide panel may be edge lit, e.g. by a light source. The light guide panel may be implemented as the diffuse light generator.

As used herein the term “light source” may refer to any arrangement capable of generating artificial light. It can include arrangements that transform electrical current into luminous radiation. The light may have wavelengths in the range of 400-700 nm. The light source can include one or more of the following: a white light source, or perceived as such by the eye, e.g. an incandescent lamp, a fluorescent lamp, a mercury vapor discharge lamp; an LED or a white light laser diode (that is, such that the primary source is combined with a phosphor or several phosphors) or a combination of LEDs or laser diodes of different colour, and; other suitable light source. The light source may include a light guide to receive light from an emitting portion and convey the light, e.g. by total internal reflection, to an output surface. The light source may be arranged to emit with a CCT of 3K to 20K, or over a daylight locus. The luminance profile may not vary by more than 20% over any area circular area of 10 mm diameter.

As used herein the term “chromatic system” may refer to an arrangement capable of imparting a particular colour to light, e.g. from the light source. The colour may be representative of skylight scene, including daylight, sunset or sunrise.

As used herein the term “filter” may refer to an optical arrangement that selectively transmits light of different wavelengths, i.e. colours, and absorbs the remainder. It may be implemented as one or more of and absorptive filter; an interference or dichroic filter; other suitable arrangement.

As used herein the term “visual cue creating system” may refer to an arrangement capable of imparting a visual cue as a visual cue component in the output light to give a perception of depth. The visual cue component may be superimposed on the diffuse light component. It may include a wall creating portion as defined herein, or other suitable arrangement such as a light spot that reflects an infinite number of times. The visual cue may convey the perception of depth by fading intensity and/or with a geometric arrangement to convey a 3-dimensional structure. The visual cue creating system may create the visual cue by implementing diffuse light, hence it may be referred to as a second diffuse light generator. The uniformity of the visual cue component may be as defined for the diffuse light component.

As used herein the term “wall creating portion” may refer to an arrangement that is capable of creating an artificial wall, which is visible when an observer gazes into the output aperture. The artificial wall may be perceived as being continuous, e.g. rather than as discrete light sources. The wall at an interior periphery may fade out, e.g. and merge into a skylight. The wall at an exterior periphery may adjoin the periphery of the output aperture. The wall creating portion may be implemented as one or more of: a fluorescent based material, e.g. as a continuous strip/portion thereof; quantum dots; other suitable arrangement.

As used herein the term “luminescent based material” may refer to a material that is solely or includes a constituent with luminescence properties. It may include a fluorescent based material. As used herein the term “fluorescent based material” may refer to a material that is solely or includes a constituent with fluorescent properties. It may include one or more of: phosphorus; gallium arsenide. A phosphorus based material may be implemented in combination with a light source that comprises blue light, such that it creates an appearance of a white wall with a blue surround.

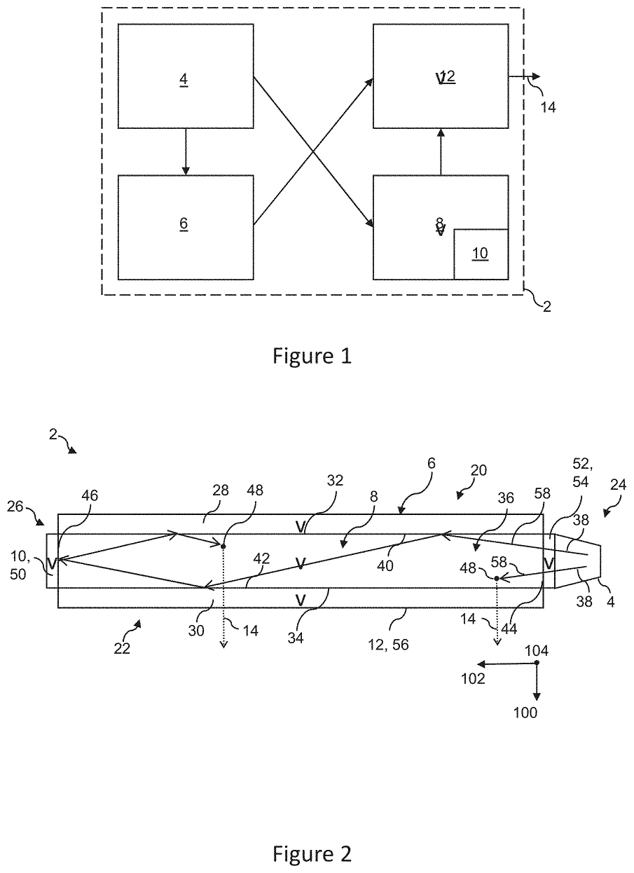

Referring to FIG. 1, the device 2 comprises a light source 4, a reflector block 6, a diffuse light generator 8; a visual cue creating system 10, and; an output aperture 12. The light source 4 transmits light to the reflector block 6 and diffuse light generator 8.

The reflector block 6 and diffuse light generator 8 can have any suitable arrangement, including one or more of: upstream or downstream of each other with respect to the light from the light source 4; coincide (e.g. the diffuse light generator is arranged in the reflector block); have separate light sources, and; other suitable arrangement.

The visual cue creating system 10 is associated with the reflector block 6, with the light reflecting within said block 6 including a visual cue imparted therefrom.

At the output aperture 12, output light 14 is transmitted that has passed through both the reflector block 6 and the diffuse light generator 8 creates a sky scene. Referring to FIG. 6, which will be discussed in more detail following, the output light 14 comprises a diffuse light component 16 generated by the diffuse light generator 8 and a visual cue component 18 generated by the visual cue creating system and reflector block 6.

The reflector block 6 comprises a reflective member and a reflective and transmissive member (not illustrated in FIG. 1). Said members are arranged as opposed planar portions, such that light from the light source 4 is reflected between them and a portion of the reflected light escapes through the reflective and transmissive member. The reflector block 6 therefore comprises a cavity defined by said members arranged to internally reflect the light until it escapes, as will be discussed in the following examples.

Various examples of the arrangement of these components will now be discussed:

Referring to FIG. 2, in a first example the device 2, which may implement any feature of the embodiments associated with FIG. 1, is arranged with the general form of a panel, which extends predominantly in a lateral direction 102 and a longitudinal direction 104 (into the plane of the page). An upper exterior surface 20 and a lower exterior surface 22 are arranged to face away from each other, and are separated in a depth direction 100. A first exterior side surface 24 and a second exterior side surface 26, are arranged to face away from each other, and are separated in the lateral direction 102.

The device 2 is configured for wall mounting, e.g. on a ceiling, vertical or otherwise extending wall of a building, with the upper exterior surface 20 to adjoin a wall, and with the lower exterior surface 22 arranged as a visible surface. By configured for wall mounting it is meant that the device 2 implements a mechanical fixing system (not illustrated) e.g. as one or more of, bolts, brackets, and wall plugs, other suitable system etc, for support of the device on a wall.

The output aperture 12 is arranged on the lower exterior surface 22. The device 2 is arranged to have a form to replicate to a window in a wall or ceiling, so that it can be implemented in a building where it may be desirable to have an actual window, but is not possible for reasons including cost and/or building geometry (e.g. in a cellar or between adjoining rooms). The form of the device 2 may therefore include a structural border (not illustrated) around a periphery of the lower exterior surface 22 to replicate a window frame. A non-emitting surface of the reflective member 28 is arranged as (or is proximal to) the upper exterior surface 20.

Although not illustrated additional members may form the periphery of the device, including a structural reinforcement forming the upper exterior surface for connection to a wall and a transparent member forming the lower exterior surface.

In variant embodiments, which are not illustrated, the device may be alternatively shaped, including with shorted lateral and/or longitudinal dimensions relative the depth or with another suitable arrangement.

The reflector block 6 is arranged with the reflective member 28 to extend in the longitudinal 104 and lateral 102 directions and proximal (or forming) the upper exterior surface 20. The reflective and transmissive member 30 extends in the longitudinal 104 and lateral 102 directions and is proximal (or forming) the lower exterior surface 22. Said members are aligned to each other in an opposed configuration, and are separated in the depth direction 100. Respective reflective surfaces 32, 34 of the reflective member 28 and reflective and transmissive member 30 define an internal cavity 36, within which light is reflected between the members.

A separation distance between the reflective member 28 and reflective and transmissive member 30 is selected to control a depth of the visual cue (as will be discussed) in the output aperture 12, e.g. the separation distance may be 1 mm-1 m, or 5 mm-50 mm.

In variant embodiments, which are not illustrated, the reflective member and reflective and transmissive member are alternatively arranged, including arranged at angles to each other or with other suitable arrangement, e.g. for the appearance of different wall effects.

The light source 4 is arranged as a 1 dimensional array of emitting portions, which are arranged to extend in the longitudinal direction 104 proximal (or forming) the first exterior side surface 26. The light source 4 is arranged to project light 38 into the cavity 36 generally in the lateral direction 102.

In variant embodiments, which are not illustrated, the light source is alternatively arranged, including as: a 2 dimensional array; a 3 dimensional array; a single source; other suitable arrangement.

The light source 4 is not observable by an observer viewing into the output aperture 12, which may be achieved by one or more of: the light source 4 may be optically decoupled from the reflector block 6 and/or the diffuse light generator depending on the arrangement of these components (e.g. by an air gap, which may be of about 2 mm or other suitable decoupling distance); the light source 4 may be collimated to prevent extreme rays escaping and coupled via a light guide to the reflector block, and; other suitable configurations. In variant embodiments, which are not illustrated, the light source is arranged to be observable.

The diffuse light generator 8 is arranged as a light guide panel, with an upper surface 40 and lower surface 42 abutting or in close proximity to the respective reflective surfaces 32, 34 of the reflective member 28 and the reflective and transmissive member 30. Hence the cavity 36 may entirely occupied in the depth direction 100 by the diffuse light generator 8 and optional associated componentry (e.g. a Newton glass layer, as will be discussed). The diffuse light generator 8 is overlapped in the lateral 102 and longitudinal 104 directions by the members 28, 30, and enclosed at the side surfaces 44, 46 by the light source 4 and visual cue creating system 10, as will be discussed. The diffuse light generator 8 implements particles 48 to generate the diffuse light component 16, which is propagate in all directions, as will be discussed.

The diffuse light generator 8 is optically decoupled from the reflective member 28 and/or the reflective and transmissive member 30 to prevent interference, such as newton rings. Said decoupling may be achieved by one or more of: an air gap, e.g. of about 2 mm; a texturization of an adjoining surface of the diffuse light generator 8 and/or members 20, 22; a newton glass layer, and; other suitable arraignment. In variant embodiments, which are not illustrated, the diffuse light generator is optically coupled.

In variant embodiments, which are not illustrated the diffuse light generator is alternatively arranged including as one or more of: the diffuse light generator arranged as a coating or adjoining layer no/to one or both of the reflective member and the reflective and transmissive member; the diffuse light generator is arranged to receive light from the light source prior to entry into the reflector block, e.g. it is interposed between the light source and reflector block; the diffuse light generator is arranged external the reflector block and to receive light transmitted through the reflective and transmitting member; the diffuse light generator is arranged as one or more of conical micro cones, micro lenses, quantum dots or other suitable diffuse light generating configuration in any of the aforesaid configurations.

In variant embodiments, which are not illustrated the diffuse light generator is omitted, e.g. the cavity 36 is empty or may comprises another medium that does not generate diffuse light, e.g. so that the light is coloured but not diffuse.

The device 2 comprises the visual cue creating system 10 implemented as wall creating portion 50. The wall creating portion 50 is arranged proximal (or to form) the second exterior side surface 26. Light 38 from the light source 4 therefore travels through the cavity 36 of the reflector block 6 (including via reflection from the members 28, 30) before encountering the wall creating portion 50. The wall creating portion 50 includes a luminescent material (e.g. a phosphorous based material) arranged on a reflective substrate (e.g. a mirror). The wall creating portion 50 is optically coupled to the second side surface 46 of the diffuse light generator 8.

In variant embodiments, which are not illustrated, the visual cue creating system is: alternately implemented or is omitted, e.g. the second exterior side surface can comprise a reflective member or a further portion of the light source instead of the visual cue creating system.

A chromatic system 52 is implemented as a filter 54 is interposed between the light source 4 and diffuse light generator 8, such that the light 56 entering the cavity 36 is coloured by the filter 54. In other variant embodiments, which are not illustrated, the chromatic system may be omitted, or other chromatic systems as disclosed herein may be implemented.

The chromatic system 52 implements a skylight colour in the light. The skylight is typically blue to represent daylight, and can be defined by a CCT of greater than 5000 k or 4500 k. In variant embodiment, the colouration system can implement alternatively colours including a more red or orange tone to represent sunset or sunrise, in which case the CCT is in the range of less than 2700 k.

In variant embodiments, which are not illustrated, the chromatic system is configured to impart a variable colour skylight colour to represent a daylight and sunrise/sunset. Such an embodiment may be implemented with the chromatic system as a variable colour light source, the colour of which is controlled by electrical circuitry. Another example implementation is a variable colour filter.

An emitting surface 56 of the reflective and transmissive member 30 forms (or is arranged proximal to) the output aperture 12 (and lower exterior surface 22 of the device 2).

Referring to FIG. 6, the output light 14 from the output aperture 12 includes the visual cue component 16, which is observed as a white/grey walled structure that virtually extends in the counter depth direction 100 into the device 2 at the peripheries of the output aperture 12. The walled structure has a three-dimensional appearance as if it were side walls of the building. The walled structure fades with increasing depth to the diffuse light component 18. The diffuse light component 18 is located at the centre of the output aperture 12 and has the appearance of a daylight skylight, and can be matched in terms of one or more of colour, intensity and diffusivity to the appearance of physical skylight.

In use, it will be understood that the device 2 implements to following process on the light 38 emitted from the light source 4.

Step 1: the light 38 enters the filter 54 and exits as coloured light 58.

Step 2: the coloured light 58 is transmitted into a side surface 44 of the diffuse light generator 8 in the cavity 36 of the reflector block 6.

Step 3A: a portion of the light 58 is transmitted through the diffuse light generator 8 via reflection from the reflective member 28 and the reflective and transmissive member 30 to the wall creating portion 50, which implements the visual cue in the light. It is subsequently reflected back into the diffuse light generator 8 until it encounters a particle 48 and is propagated as diffuse light, with a portion of the scattered light transmitted through the reflective and transmissive member 30 to the output aperture 12 as the output light 14.

Step 3B: a portion of the light 58 may be transmitted through the diffuse light generator 8 and encounters a particle 38 (e.g. prior to reflection between the members 28, 28 and/or prior to reflection from the wall creating portion 50) and is propagated as diffuse light, with a portion of the scattered light transmitted through the reflective and transmissive member 30 to the output aperture 12 as the output light 14.

Step 3C: a portion of the light 58 transmitted in the cavity 36 of the reflector block 6 may exit via the reflective and transmissive member 30 as the output light 14 without encountering a particle 48, including before or after being transmitted to the wall creating portion 50.

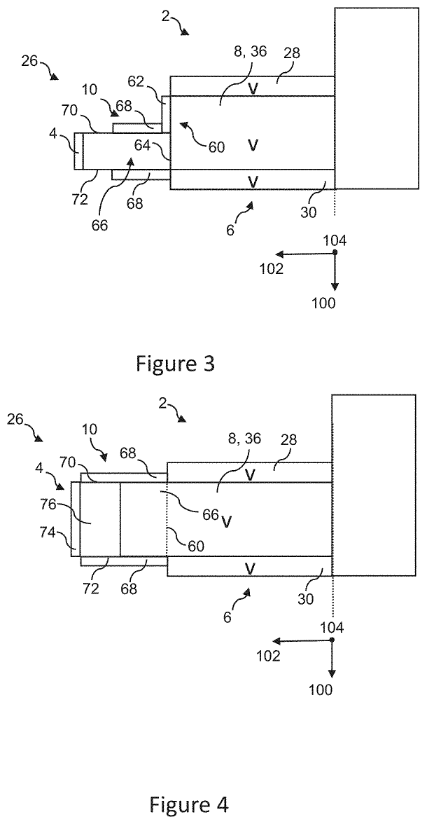

Referring to FIG. 3, in a second example the device 2 is as described for the first example, but has an alternative arrangement at the sides 24, 26 of the device 2. The light source 4 and wall creating portion 50 are arranged both at the same side and both sides may be symmetrical with respect to each other (or the other side may comprise a reflective member), hence FIG. 3 only shows the arrangement at the second side 26.

A side wall 60 of the reflector block 6 includes, optically coupled thereto, the visual cue creating system 10 arranged as a first wall creating portion 62. The first wall creating portion 62 extends in the depth direction 100 from proximal the reflective member 28.

The side wall 60 of the reflector block 6 further includes and an inlet 64 for the light 38 from the light source 4, which extends from the first wall creating portion 62 in the depth direction 100 to the reflective and transmissive member 30. A coupling 66 extending in the lateral direction 102 connects the light source 4 to the inlet 64. The coupling 66 is arranged as an extension of the diffuse light generator 8 arranged in the cavity 36.

The coupling 6 includes second wall creating portions 68, which are arranged on an upper surface 70 and a lower surface 72 of the coupling 66. The second wall creating portions 68 extend from the inlet 64 partially along the coupling 66 in the lateral direction 102.

In variant embodiments, which are not illustrated: the coupling comprises a medium other than the diffuse light generator, including the filter, a light guide, other arrangement; the inlet may be arranged proximal the reflective member rather than proximal the reflective and transmissive member or with the first wall creating portions on either side; one of the first or second wall creating portions may be omitted; the second wall creating portions extend from the inlet along the coupling in the lateral direction up to the light source.

Referring to FIG. 4, in a third example the device 2 is as described for the second example, however the coupling 66 is arranged entirely across the side wall 60, and the first wall emitting portion is omitted.

The coupling 66 includes the second wall creating portions 68, which are arranged on an upper surface 70 and a lower surface 72 of the coupling 66. The second wall creating portions 68 extend from the members 28, 30 along the coupling 66 in the lateral direction 102 to the light source 4. The light source 4 is implemented as an emitting portion 74 and with a light guide 76 arranged as part of the coupling 66 to couple the light to the diffuse light generator 8, which is arranged as an adjoining portion of the coupling 66.

In the above embodiments, the wall creating portion may be optically coupled (e.g. via a direct surface to surface connection) or decoupled to the adjacent component (including the light guide panel or reflector block). Decoupling can be achieved by an air gap (e.g. of about 2 mm). Wall creating portions arranged to extend in the depth direction may be coupled, and wall creating portion arranged to extend in the lateral direction may be decoupled, e.g. to enable light to escape from the light guide panel.

In variant embodiments, which re not illustrated, a dedicated light source may transmit light directly to the wall creating portion. In this way by varying an intensity of the dedicated light source, the depth and intensity of the virtual wall may be adjusted relative the skylight created by the light source 4.

In a fourth example (which is not specifically illustrated, but with reference to FIG. 2) the visual cue creating system 10 is arranged in the cavity 36 of the reflector block 6. For example, it may be arranged as a coating on the upper surface 40 and/or lower surface 42 of the diffuse light generator 8. It may alternatively be arranged on a separate carrier (not illustrated) which overlaps the diffuse light generator, e.g. a transparent member including class or plastic. In particular, the visual cue creating system 10 can be arranged around a periphery of the reflector block either on the diffuse light generator 8 or on said separate carrier like a picture frame extends around a periphery of a picture.

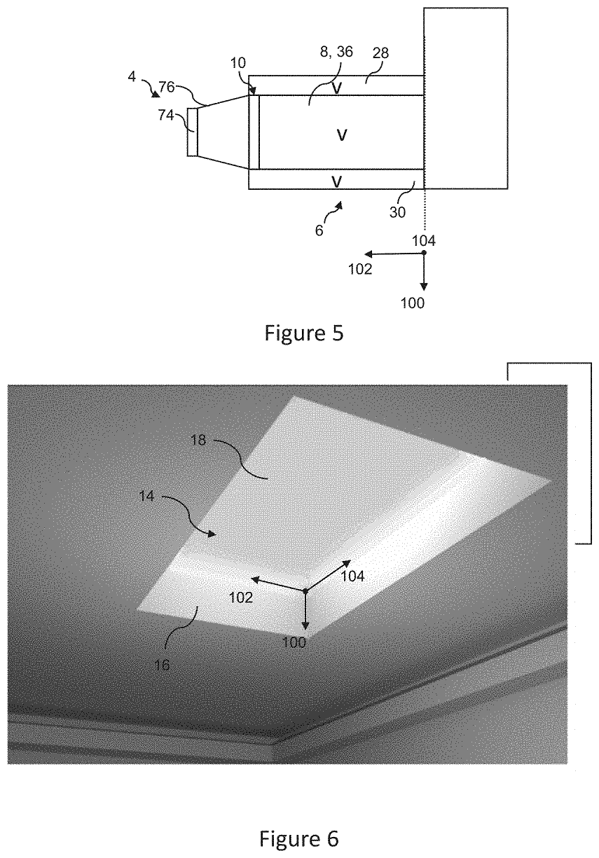

Referring to FIG. 5, in a fifth example, the visual cue creating system 10 is arranged between the light source 4 and the diffuse light generator 8, such that the light from the light source 4 projects directly through the visual cue creating system 10 an into the light guide panel of the diffuse light generator 10. In particular, the visual cue creating system 10 is arranged as a series of discrete units (not individually illustrated) on or otherwise optically coupled to a side surface of the diffuse light generator 10. The discrete units may have a diameter of 5 micrometres to 5 mm and may be separated by the a gap of 5 micrometres to 5 mm. A gap between the discrete units enables a portion of the light from the light to pass though the visual cue creating system without the visual cue implemented therein.

The visual cue creating system 10 can be implemented on one or more sides (including all sides) of the device. The visual cue creating system 10 is formed by printing on to the relevant surface

In variant embodiments, which are not illustrated: the discrete units may have other arrangements, e.g. other sizes and/or separation distances; they may be arranged on the filter or a dedicated carrier component other than the light guide panel, and; the visual cue creating system can be formed by means other than printing; in an example where the diffuse light generator is arranged outside of the reflector block and downstream of the light emitting and transmitting member the arrangement of the fifth example can be adapted so that the visual cue creating system couples to a side of the reflector block rather than the diffuse light generator.

The arrangement of the visual cue creating system in any embodiment disclosed herein may be combined with any suitable combination, e.g. the fourth example in combination with the first example. The arrangement of the visually cue creating system is generally in proximity (including at) to a periphery (including on one or more or all edges) of the reflector block. For example, for the fourth example it can extend around the entire periphery of the diffuse light generator or the carrier.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 Device
   4 Light source
      38 Light direct from light source
      74 Emitting portion
      76 Light guide
   6 Reflector block
      28 Reflective member
         32 Reflective surface
         36 Cavity
         58 Light in reflector block
      30 Reflective and transmissive member
         34 Reflective and transmissive surface
         56 Emitting surface
      60 Side wall
         64 Inlet
   8 Diffuse light generator
      40 Upper surface
      42 Lower surface
      44 First side surface
      46 Second side surface
      48 Particles
      66 Coupling
         70 Upper surface
         72 Lower surface
   10 Visual cue creating system
      50 Wall creating portion
         62 First wall creating portion
         68 Second wall creating portion
   12 Output aperture
      14 Output light
         16 Diffuse light component
         18 Visual cue component
   20 Upper exterior surface
   22 Lower exterior surface (output aperture)
   24 First exterior side surface
   26 Second exterior side surface
   52 Chromatic system
      54 Filter
   100 Depth direction
   102 Lateral direction
   104 Longitudinal direction

1. An optical display device arranged to create a perception of a sky scene in output light, the device comprising:
a light source;
a reflector block having a reflective member and a reflective and partially transmissive member;
a diffuse light generator;
a visual cue creating system associated with the reflector block, and;
an output aperture for the output light,
the light source arranged to transmit light to the reflector block for reflection between the reflective member and the reflective and partially transmissive member, with said light being transmitted through the reflective and partially transmissive member to the output aperture,
wherein the diffuse light generator is arranged to generate in the output light a diffuse light component to replicate a skylight from the light transmitted from the light source,
and the visual cue creating system implements in the light in the reflector block a visual cue which is arranged to provide in the output light a visual cue component that an observer associates with depth.

2. The optical display device of claim 1, wherein the diffuse light generator is arranged as one or more of:
between the reflective member and the reflective and partially transmissive member of the reflector block;
arranged to receive the light after it is transmitted through the reflector block, and;
upstream of the reflector block.

3. The optical display device of claim 2, wherein the diffuse light generator is arranged as a light guide panel, which is edge lit by light from the light source.

4. The optical display device of claim 3, wherein the light guide panel is optically decoupled from the reflective member and/or the reflective and partially transmissive member.

5. The optical display device of claim 1, wherein the diffuse light generator generates the diffuse light component with a degree of diffusivity to correspond to skylight.

6. The optical display device of claim 5, wherein the diffuse light generator includes particles to scatter said light.

7. The optical display device of claim 1, wherein the diffuse light component is emitted over a central portion of the output aperture and the visual cue component is emitted at a peripheral portion of the output aperture and
the diffuse light component is uniform over the central region.

8. The optical display device of claim 1, wherein the diffuse light component comprises a skylight, that consists of one or more of: daylight; sunset, and; sunrise, and
diffuse light component is daylight and has a CCT of greater than 5000 k.

9. The optical display device of claim 1, wherein a chromatic system imparts a skylight colour in the diffuse light component, the chromatic system comprising one or more of:
the light source arranged to emit a particular wavelength of light;
the diffuse light generator, and;
a filter.

10. The optical display device of claim 1, wherein the visual cue creating system is implemented as a wall creating portion, which is arranged to give in the visual cue component a perception of a virtual wall with depth extending into the output aperture,
wherein the virtual wall is continuous and extends around an entire periphery of the output aperture.

11. The optical display device of either of claim 10, wherein the virtual wall has a CCT of 4500K to 6500K.

12. The optical display device of any of claim 10, wherein the wall creating portion includes a luminescent based material and
the luminescent based material is phosphorus based.

13. The optical display device of claim 1, wherein the light source and visual cue creating system are arranged with the visual cue creating system to receive light from the light source that has been transmitted between the reflective member and the reflective and partially transmissive member.

14. The optical display device of claim 1, wherein an edge of the reflector block includes:
an inlet portion to receive light from the light source, and;
the visual cue creating system.

15. The optical display device of claim 1, wherein the reflector block and visual cue creating system are arranged with light from the light source transmitted to the visual cue creating system upstream of the reflector block.

16. The optical display device of claim 1, wherein the visual cue creating system is arranged within the reflector block and/or is coupled to a side surface of the diffuse light generator which is arranged at least partially within the reflector block.

17. The optical display device of preceding claim 1, wherein the visual cue creating system is arranged at a periphery of the reflector block.

18. The optical display device of claim 1, wherein the light source includes a light emitting portion and a light guide to collect the light from the light emitting portion.

19. A kit of parts for assembly into the optical display device of claim 1.

20. A method of creating a perception of a sky scene comprising:
transmitting light comprising a visual cue between a reflective member and a reflective and partially transmissive member to generate a visual cue component;
transmitting light to a diffuse light generator to generate a diffuse light component.
